(19) United States
(12) Patent Application Publication
(10) Pub. No.: US 2017/0342511 A1
(43) Pub. Date: Nov. 30, 2017

(54) PROCESS FOR THE ISOLATION OF MONOSACCHARIDES

(71) Applicant: BIOECON INTERNATIONAL HOLDING N.V., HOEVELAKEN (NL)

(72) Inventor: JOHAN VAN DEN BERGH, DORDRECHT (NL)

(73) Assignee: BIOECON INTERNATIONAL HOLDING N.V., HOEVELAKEN (NL)

(21) Appl. No.: 15/534,515

(22) PCT Filed: Nov. 25, 2015
(86) PCT No.: PCT/EP2015/077626

§ 371 Date: Jun. 9, 2017

(30) Foreign Application Priority Data
Dec. 9, 2014 (EP) 14196979.0

(51) Int. Cl. C13K 1/04; C13K 11/00; C13K 13/00

(52) U.S. Cl. CPC C13K 1/04; C13K 13/007; C13K 11/00; C13K 13/002

(57) ABSTRACT

A process for the separation of a monosaccharide from an aqueous solution comprising the monosaccharide, in particular a hydrolysate of a polysaccharide containing biomass, characterized in that a) the solution comprises one or more salts or mineral acids, b) the solution is contacted with a zeolite adsorbent preferably of BEA zeotype for adsorbing the monosaccharide on the zeolite, c) the zeolite with the adsorbed monosaccharide is separated from the solution, d) the monosaccharide is separated from the zeolite absorbent. The process in a chromatographic process, in particular SMB, produces relatively highly concentrated and pure monosaccharide solution in water.

### BACKGROUND OF THE INVENTION

### 1. Field of the Invention

The present invention relates to a process for isolation of monosaccharides from an aqueous solution, in particular from hydrolysates of polysaccharide containing biomass. There is a significant interest to use biomass as renewable resources for making monosaccharides and for making bio-based platform chemicals derived directly or indirectly from monosaccharides as replacement for chemicals from petrochemical origin. Preferred examples of biomass materials include agricultural wastes, such as bagasse, straw, corn stover, corn husks and the like. Bagasse is the fibrous matter that remains after sugarcane or sorghum stalks are crushed to extract their juice. Known uses are for example fuel additives, fuel replacement, and monomers for bio-based polymers.

Typical feedstock is ligno-cellulosic biomass. Ligno-cellulosic biomass comprises three main components lignin, amorphous hemi-cellulose and crystalline cellulose. The components are assembled in such a compact manner that makes it less accessible and therefore less susceptible to chemical conversion. Amorphous hemi-cellulose can be relatively easily dissolved and hydrolysed, but it is much more difficult to convert cellulose in a cellulose containing feedstock in an low cost process. The very crystalline and stable cellulose, is often also entangled into the lignin, making it poorly accessible to any reactant or catalyst.

It is known to convert ligno-cellulosic biomass directly to platform chemicals by thermo-catalytic means, such as pyrolysis, catalytic pyrolysis and via hydrothermal (HTU) and/or solvo-thermal processes. Because the very crystalline and stable cellulose is entangled into the lignin, making it poorly accessible to any reactant or catalyst the cellulose liquefies only at temperatures above 300° C.-350° C. and only then can start its catalytic conversion to oil products. At these high temperatures however the monomeric and oligomeric saccharides produced are easily degraded into char and tar or over-cracked into gas, with as a result that the state-of-the art processes give poor liquid yield (high coke and gas) and are difficult to operate (Plugging by char and tar). Various processes have been proposed for the conversion of a cellulose containing feedstock that all struggle with the above problem.

Other processes involve converting the polysaccharide to the monomeric saccharides, in particular glucose, in acid a molten salt hydrate and then derivatising the monosaccharides to derivatives that can be more easily separated from the molten salt hydrate. The hydrolysis and dissolution of the cellulose typically involves contacting with strong acids or in solution of an inorganic molten salt hydrate or in a combination thereof. The temperatures are lower, which is an economic and process technical advantage, and also less byproducts are formed then at high temperature processes. However, it is difficult to separate the monosaccharides from the obtained aqueous solution.

### 2. Description of the Related Art

WO2009/112588 describes a process for converting polysaccharides to a platform chemical, wherein the difficulty of separation of the formed monosaccharides from the inorganic molten salt hydrate is solved by derivatising the monosaccharide in the molten salt hydrate solution by to a more easily separable derivative.

WO2010/106053 also describes a process for converting a polysaccharide-containing material to a fuel additive or a fuel substitute material, said process comprising the steps of: (i) dissolving the polysaccharide-containing material in an inorganic molten salt hydrate; (ii) hydrolyzing components of the cellulose-containing material in the inorganic molten salt hydrate medium to form monosaccharides; (iii) hydrogenating the monosaccharides obtained in step (ii) in the inorganic molten salt medium to the corresponding sugar alcohols, (iv) dehydrating the sugar alcohols obtained in step (iii) in the inorganic molten salt medium to form the corresponding anhydro sugars and/or dianhydro sugars; (v) derivatising the (di) anhydro sugars obtained in step (iv), in the inorganic molten salt medium to form derivatized (di) anhydro sugars having reduced solubility in the inorganic molten salt hydrate medium.

U.S. Pat. No. 4,452,640 discloses a process to dissolve and quantitatively hydrolyze cellulose to glucose without formation of degradation products, using ZnCl₂ solutions. Dissolution was effected with salt solutions, with ZnCl₂ being preferred, at sufficiently large contact time and temperatures of 70° C. to 180° C. After dissolution, the ZnCl₂ concentration was lowered prior to hydrolysis to avoid glucose degradation and subsequently HCl or a similar acid was added to effect complete hydrolysis to glucose. It is described that glucose removal from the ZnCl₂ solution is very difficult and it is suggested to use ion exchange resins for separation. A similar process to convert cellulose to glucose is described in U.S. Pat. No. 4,525,218 wherein, after partial hydrolysis of the cellulose in ZnCl₂, degradation of the glucose is prevented by separating the ZnCl₂ by precipitation of the cellodextrins which then are further hydrolised in the absence of ZnCl₂.

EP0265111A2 (ICI) describes a process for converting a polysaccharide-containing material to monosaccharides (Xylose) by hydrolysing in acid, purifying, concentrating, mixing with ethanol and crystallising the xylose.

U.S. Pat. No. 4,133,696 describes a process for the separation of a sugar or a mixture of sugars, in particular an aldose such as glucose or a ketose such as fructose or a mixture thereof, from an ion-containing mixture comprising the sugar or mixture of sugars and oxyanions wherein the ion-containing mixture is contacted with (A) a cationic exchange resins to remove the ions.

GB1540556 describes a process for separating mannose from an aqueous solution containing glucose and mannose which comprises: (a) contacting said solution with a bed of cation exchange resin in a salt form; and (b) eluting said resin with water to obtain a mannose-rich eluate fraction.

EP0074713 describes a process for concentrating mannose in an aqueous carbohydrate solution containing glucose and mannose having a carbohydrate solids content of 60-88% by weight which comprises the steps of:
(a) forming an insoluble glucose hydrate/sodium halide adduct in said carbohydrate solution,
(b) separating said insoluble adduct from said aqueous solution, and
(c) collecting the mannose rich solution resulting therefrom.

### BRIEF SUMMARY OF THE INVENTION

Therefore, there still remains a desire for economically and environmentally friendly processes for separating monosaccharides from an aqueous solution, in particular from a hydrolysate of a polysaccharide containing biomass, in particular from bio-mass resources that do not compete with the food-chain.

There is a particular interest in separation of monosaccharides from aqueous solution because monosaccharides like glucose, xylose and mannose have significant direct use and commercial interest but they are also a more attractive starting point for making interesting derivative molecules in higher yield and purity and with less complicated processes. However, processes to separate monosaccharides from aqueous solution to produce monosaccharide from polysaccharide containing feed have not yet been economically and commercially successful.

According to the invention there is provided a process for the separation of a monosaccharide from an aqueous solution comprising the monosaccharide characterized in that
a) the solution comprises one or more salts and/or mineral acids,
b) the solution is contacted with a zeolite adsorbent for adsorbing the monosaccharide on the zeolite,
c) the zeolite with the adsorbed monosaccharide is separated from the solution,
d) the monosaccharide is separated from the zeolite absorbent.

The inventors have found that monosaccharides adsorb on a zeolite adsorbent if the aqueous solution comprises one or more salts and/or mineral acids preferably in high concentration which allows the adsorbed monosaccharides to be separated from the solution producing after desorption separation from the adsorbent in a separated monosaccharide. The separation process steps b)-d) are for example conveniently carried out in a chromatography type of process wherein the zeolite adsorbent is the stationary phase and water is used as eluent.

It has been found that good results can be obtained if the zeolite is characterised by pore opening with at least 12 T atoms. Further it is preferred that the zeolite has a cavity size of less than 1 nm (i.e. largest sphere that can be included smaller than 1 nm as defined by the international zeolite association (http://www.iza-structure.org/databases/). Suitable zeolite are selected from, but is not limited to, the group of BEA, MOR or FAU zeolites and the most preferred zeolite is BEA.

The zeolite preferably has a high porosity defined as a BET surface area of more than 400, preferably more than 450, 500 or even 550 m²/g. Optimum results were found if the zeolite has a silica to alumina ratio between 5 and infinite, more preferably between 10 and 150, most preferably between 10 and 50. Experimental data on glucose adsorption show that a too high SAR, implying high hydrophobicity, is not preferred since it leads to a lower glucose loading and a too low SAR (high hydrophilicity) also leads to lower glucose loading probably because water adsorption can become dominant and inhibit monosaccharide adsorption.

The zeolite are preferably shaped zeolites in the form of extrudates, spheres, granulates, preferably with a cylindrical or spherical diameter between 100-1500, preferably between 200-1000 or 250-750 micron. The shaped zeolite comprise zeolite in the form of powder and a binder. The binder preferably is one or more chosen from the group of clay, alumina, silica, titiania and zirconia and most preferably is silica. The zeolite adsorbent, preferably BEA, preferably has a silica based zeolite framework wherein part of the Si atoms are substituted by Al with a silica-alumina ration as described above and optionally with Ti, Ge, Sn, Zn. The advantage of silica based BEA and also of silica binder in the shaped zeolite is that it is more resistant against degradation in high acidic solutions used for hydrolysing polysaccharides, in particular in concentrated ZnCl solutions comprising mineral acid. In a particular embodiment the zeolite adsorbent also has catalytic properties for conversion of the adsorbed monosaccharides, preferably at elevated temperatures.

The aqueous solution must comprise a salt, a mineral acid or mixtures thereof, to assist the adsorption on the zeolites. The preferred salts comprise a cation selected from the group of Na, Li, Ca, Zn, Cu, Mg, Fe and a counterion where specifically chloride anions were found to be very effective. Suitably also mineral acid can be used preferably HCl or H₂SO₄.

In the process according to the invention the amount of salt or mineral acid in the aqueous solution can be between 1 and 70 wt %, but is preferably high because generally higher adsorption is achieved at higher salt concentrations. Preferably the amount is between 5 and 60 wt %, more preferably between 10, 15, 20, 25, 30 or 35 wt % and 60 wt % relative to the total amount of water and salt or mineral acid and, in particular for monovalent cations, most preferably close to the saturation concentration. Different salts have different degree of adsorption promotion and the optimum amount can be established by the skilled person in accordance with the examples herein described.

In a particularly preferred embodiment of the process the aqueous solution comprises a salt chosen from the group of ZnCl₂, CaCl₂, LiCl or mixtures thereof, preferably substantially only ZnCl₂. These salts show strong improvement of adsorption on the zeolite but are also potent solvent for dissolving and hydrolysing polysaccharides. It was surprisingly found that ZnCl₂ shows an optimum in adsorption promotion around 50 wt % relative to the total amount of water and salt and mineral acid, after which the adsorption decreases steeply. Therefore, it is preferred that the amount of ZnCl₂, in the aqueous solution is between 30 and 70 wt %, preferably 40-60 wt % and most preferably 45-55 wt % relative to the total amount of water and salt and mineral acid. These amounts apply to monosaccharide content relative to total aqueous solution weight ranging between 1 and 50, 40, 30, 20 or 10 wt %. In particular for bivalent cation salts it is believed that adsorption promoting effect is not always present with increasing concentration because these salts can form complexes at higher concentrations that reduce the efficacy of the salt. In such case further improvement can be achieved if the aqueous solution comprises a mixture of a bivalent cation salt and a monovalent cation salt or a mineral acid or both. For example, to further improve the adsorption in the process between 30 and 64 wt % ZnCl₂ is combined with between 1 and 15 wt % Na or Li chloride and/or less preferably 0.1-20 wt % mineral acid.

It has been found that for the purpose of achieving high adsorption, the presence of mineral acid in combination with salt, in particular ZnCl₂, is not always preferred. Therefore, the aqueous solution before contacting with the zeolite preferably does not comprise mineral acid. However, good separation results can still be achieved when a mineral acid is present in the aqueous solution. The presence of an acid with the salt is typically preferred in the biomass hydrolysis reaction before the separation step to reach the hydrolysation equilibrium faster and maximize the relative amount of monosaccharides that can be separated. In an alternative embodiment, the polysaccharide hydrolysate comprises a mineral acid, but the mineral acid is removed from the aqueous solution before, and preferably just before, contacting with the zeolite, preferably using Liquid/Liquid extraction with an amine, adsorption with an ion-exchange resin or zeolite, evaporation or neutralization, e.g. with ZnO.

The aqueous solution typically is a polysaccharide hydrolysate, preferably a hydrolysate of a polysaccharide containing bio-mass and most preferably a lignocellulosic biomass that is not edible. The hydrolysate can be prepared in various ways known in the art, for example using concentrated H₂SO₄ or HCl. The aqueous solution typically comprises monosaccharides, disaccharides and optionally higher oligomer saccharides and even minor amounts of dissolved unhydrolised polysaccharide. The hydrolysation is an equilibrium reaction which after sufficient time results in equilibrium amounts of polysaccharide derived components in the solution, depending on solvent composition and temperature. In view of productivity of the separation process it is preferred that the amount of monosaccharides relative to the total weight of the aqueous solution is between 1 and 60 wt %, preferably 2 and 50 wt %, more preferably 3 and 40 wt %, most preferably 5-20 wt %.

It has been found that the separation process has a very good selectivity for separating monosaccharides from disaccharides or higher oligomers. In the process, apart from the monosaccharides also dimer and oligomer saccharides can be separated from the aqueous solution with high selectivity. In view of monosaccharide productivity the amount of monosaccharide in the aqueous solution relative to the total amount of polysaccharide hydrolysate (i.e. only saccharide components; not including water and salt) is at least 30, 40, 50 or even at least 60 wt %. The maximum monomer formation during hydrolysis is limited by an equilibrium. A typical approach to maximize monomer formation is to dilute the salt/acid solution with water and perform further hydrolysis. However, this leads to dilute sugar streams (large equipment) and a large amount of water that needs to be removed. An advantage of the current invention is that the unhydrolysed oligomers remain with the salt/acid solution and can be recycled or directly further hydrolysed or separated with another technique like precipitation. In this way the overall monomer yield can, in principle be 100%, without performing a hydrolysis step at high dilution. Still a high fraction of monomers is preferred for maximum productivity as discussed before.

Care must be taken that the hydrolysis is done mildly in a way to not produce too much side products. The aqueous solution preferably comprises less than 30, preferably less than 25, 20, 15, 10 or 5 wt % of mono-saccharide derived side products, in particular polyols or anhydro-saccharides like furfural, hydroxymethylfurfural and anhydroglucose, because these side products tend to compete with the monosaccharide adsorption and reduce the efficacy of the monosaccharide separation. In case significant side product amounts are present it is preferred to separate these from the aqueous solution before separating the mono-saccharides.

In a preferred process according to the invention the aqueous solution is obtained by a process for the conversion of a polysaccharide containing bio-mass, preferably ligno-cellulosic bio-mass, wherein the polysaccharide containing biomass is contacted with an inorganic molten salt hydrate and preferably also a mineral acid and the polysaccharide is dissolved and hydrolyzed in the inorganic molten salt hydrate. The hydrolysis temperature is 60-180, preferably 80-150° C. Herein the inorganic molten salt hydrate preferably is chosen from the group of ZnCl₂, CaCl₂, LiCl or mixtures thereof, preferably at least 60% of the salt in the inorganic molten salt hydrate is ZnCl₂ and most preferably the inorganic molten salt hydrate substantially consists of ZnCl₂ hydrate.

Ligno-cellulosic bio-mass comprises cellulose, hemicellulose and lignin. The hemicellulose can be simply extracted as is known in the art with dilute acid, but it is preferred that the hemicellulose is selectively hydrolysed in molten ZnCl₂ hydrate wherein the ZnCl₂ salt is present in an amount between 30 and 50wt %, preferably in presence of a mineral acid, preferably HCl, and in accordance with the process of the invention separated by contacting with the zeolite adsorbent and separation of monosaccharides xylose, glucose and arabinose.

The cellulose is preferably hydrolysed in molten ZnCl₂ hydrate wherein the ZnCl₂ salt is present in an amount between 62 and 78, more preferably between 65 and 75 and most preferably between 67.5 and 72.5 wt %, relative to the total amount of water and salt. preferably in presence of a mineral acid, preferably HCl, followed by separation of monosaccharide glucose. Alternatively the cellulose and hemicellulose are both simultaneously hydrolysed in molten ZnCl₂ hydrate wherein the ZnCl₂ salt is present in an amount between 62 and 78, more preferably between 65 and 75 and most preferably between 67.5 and 72.5 wt %, preferably in presence of a mineral acid, preferably HCl, followed by separation of obtained monosaccharides. To effectively hydrolyse the cellulose, the total amount of water present in the hydrolysing step is between 20 and 40 wt %, preferably 25 and 35 wt % relative to the total weight of the solution. The mass ratio of bio-mass relative to molten salt hydrate is between 1/5 and 1/30 preferably between 1/5 and 1/10.

When the cellulose containing feed is a lignocellulosic biomass the lignin is removed after hydrolysis and dissolution of the cellulose for example by filtration and before the separation step. Optionally the aqueous solution is purified before separation to remove impurities like acid soluble lignin and side products like anhydrosugars, hydroxymethylfurfural and furfural.

As the preferred ZnCl₂ concentration for hydrolysis is higher than the optimum for separation on the zeolite adsorbent after the hydrolisation step and before contacting with the zeolite adsorbent, the obtained hydrolysate is diluted to reduce the ZnCl₂ content such that the aqueous solution comprises between 30 and 70 wt %, preferably 40-60 wt % and most preferably 45-55 wt % ZnCl₂ relative to the total amount of water and salt and mineral acid. Note that there can be an economic incentive to not dilute to the optimal ZnCl₂ content to operate the separation process.

In a particular embodiment of the process mild hydrolysis conditions are being used, in particular that no mineral acid is added and by consequence also no mineral acid removal step needs to be used. Further, in the mild hydrolysis conditions it is preferred that during the hydrolysis step the temperature is low; between 90° C. and 120° C. and the pressure is atmospheric pressure. This not only has process economic advantages but the advantage of the mild hydrolysis conditions using low acidity is also that small amounts of side products (in particular monosaccharide degradation products) are formed. These side products disturb the monosaccharide adsorption and cause lower yields of monosaccharides. Organic acids can be added but preferably the pH is autogenic. The pH of the molten salt hydrate solvent in the hydrolyzing step is hence preferably between −3 and 7, preferably the pH is higher than −2.5, more preferably −2, and for feedstock not containing acetyl groups, in particular cellulose or feedstock from which acetyl groups have been removed or feedstock from which hemicellulose has been removed, the pH is preferably higher than −2 or more preferably higher than −1.5. In such mild hydrolysis conditions a relatively high percentage of oligomers and a relatively low amount of monosaccharides are formed. However, oligomeric polysaccharides are easily separated by precipitation with an anti-solvent before or after the separation of the monosaccharides. Furthermore, if the contact time with the zeolite is sufficiently long, the removal of the monosaccharide from the solution by the zeolite causes a shift in equilibrium towards more monosaccharides, so the separation process produces more monosaccharides than are present in equilibrium in the aqueous solution.

The process can be a batch, a recycling batch, a multi-column or simulated-moving-bed-type process. The process according to the invention is preferably a chromatographic process wherein the zeolite adsorbent is the stationary phase and preferably the eluent is water, preferably at temperatures between 20° C. and 120° C. The advantage of the process of the invention is that good adsorption and peak separation can be achieved also at higher temperatures, which requires less cooling when the polysaccharide hydrolysate goes directly to the separation step. The process results in an extract aqueous solution comprising between 3 and 40 wt % of the monosaccharide in water. A clear advantage of the invention is that because the salt promotes adsorption, upon separation of the monosaccharide from the salt, desorption of the monosaccharide is promoted, hence water acts as desorbent. This leads to the opportunity to obtain very concentrated sugar solutions that can be directly fermented. The extract can be obtained with a yield of preferably more than 90, preferably 95 wt % (monosaccharide amount separated relative to the amount in the aqueous solution) and a monosaccharide purity of at least 90, preferably 95 wt %. The salt and/or acid yield in the raffinate is at least more than 95% and preferably more than 99%.

The obtained extract can be further purified by one or more of the following processes:
a) Removal of Zncl₂ by: ion exchange resins, electrodialysis, another chromatographic step with ion exclusion resins,
b) Removal of oligomers or other impurities by: activated carbon treatment, another chromatographic separation, membrane separation. Oligomers can be precipitated with a anti solvent.

The invention is illustrated by the following examples.

### EXAMPLES

Table 1 lists various zeolite adsorbents (also referred to as sorbents) and Table 2 lists typical properties of a variety of Zeotypes.

TABLE 1

| | | | | BET area, | | | |
|---|---|---|---|---|---|---|---|
| Sorbent | Supplier | Zeotype | SAR* | m²/g | Cation | Geometry | Binder** |
| RT-12/015A | Petrobras/Tricat | MFI | 26 | | H+ | Extrudates (1/8″) | Alumina |
| RT-12/015C | Petrobras/FCC | FAU | 5 | | H+ | Extrudates (1/8″) | Alumina |
| RT13/016A | Petrobras/Zeolyst | BEA | 38 | | H+ | Extrudates (1/8″) | Alumina |
| RT13/016B | Petrobras/Zeolyst | FAU | 80 | | H+ | Extrudates (1/8″) | Alumina |
| RT13-016C | Petrobras/FCC | MFI | 41 | | H+ | Extrudates (1/8″) | Alumina |
| CBV-28014 | Zeolyst | MFI | 280 | 400 | NH₄+ | Powder | n.a. |
| CBV-400 | Zeolyst | FAU | 5.1 | 730 | H+ | Powder | n.a. |
| CBV-90A | Zeolyst | MOR | 90 | 500 | H+ | Powder | n.a. |
| CP811C-300 | Zeolyst | BEA | 300 | 620 | H+ | Powder | n.a. |
| CP-814C | Zeolyst | BEA | 38 | 710 | NH₄+ | Powder | n.a. |
| CP-814E | Zeolyst | BEA | 25 | 680 | NH₄+ | Powder | n.a. |
| MCM-41 | Zeolyst | MCM-41 | Inf. | | n.a. | Powder | n.a. |
| Microsphere | Brace/Zeolyst | BEA | 25 | | H+ | Spheres (300 | Silica |
| | | | | | | um) | |
| PP1519 | Tricat | MOR | | | | Powder | n.a. |
| MP2101 | Petrobras | MOR | | | | Powder | n.a. |
| AM1787 | Zeolyst/Petrobras | BEA | 38 | | | Extrudates (1/8″) | Alumina |
| AM1291 | | FER | | 400 | | Extrudates (1/8″) | Alumina |

*SAR: Silica to Alumina ratio
**Binder is 20% of the total adsorbent mass

TABLE 2
Typical properties of a variety of Zeotypes*.

| | T-atoms | Largest sphere | Largest sphere that | Accessible |
|---|---|---|---|---|
| | in | that can diffuse | can be included | volume by water |
| Zeotype | window | A° | A° | % |
| MFI | 10 | 4.5 | 6.36 | 9.9 |
| FER | 10 | 4.69 | 6.31 | 10 |
| MOR | 12 | 6.45 | 6.7 | 12.6 |
| BEA | 12 | 5.95 | 6.68 | 22.5 |
| FAU | 12 | 7.35 | 11.24 | 27.6 |

*http://www.iza-structure.org/databases/

### EXAMPLE 1

### Glucose and Cellobiose Adsorption on Various Zeolites

Various sorbents were added in a weight ratio of 1:10 to a solution (=feed solution) containing 6 wt % Glucose, 2 wt % Cellobiose, 50 wt % ZnCl₂ and 42 wt % water. The samples were shaken regularly and left standing for 24 h at room temperature. The fraction of glucose and cellobiose remaining in solution after contact with the sorbent (xw,Fin) was measured using Agilent Infinity HPLC equipped with RID and UV-VIS detectors using a Biorad Aminex HPX-87H Column. The Glucose and Cellobiose loadings (q) were calculated from the composition of the feed solution (xw,Feed), the solution after contact with the sorbent (xw,Fin), solution mass (msol) and sorbent mass (msorb) added:

$$q = \frac{{m}_{Sol}}{{m}_{Sorb}} ( {x}_{w , Feed} - {x}_{w , Fin} )$$

Note that the volume of the liquid phase is assumed to be constant. In case of preferential water adsorption, the weight fraction of ZnCl₂ and sugars could increase and the calculated loading becomes negative.

Note that due to the high ZnCl₂ concentration it is difficult to calculate the ZnCl₂ loading if this loading is very low because small errors in the concentration can lead to large errors in the calculated loading (xw,Feed˜xw,Fin). These adsorption equilibrium experiments therefore reveal the capacity for the sorbent for the sugars, but is a poor indication of the ZnCl₂ co-adsorption. The ZnCl₂ loading is not reported for this reason.

The results of the Adsorption equilibrium screening of different sorbents for the ZnCl₂/Glucose/Cellobiose system (model for a cellulose hydrolysate) are presented in table 3.

TABLE 3

| | | | Loading, g/g sorbent | |
|---|---|---|---|---|
| | Zeotype | SAR | Cellobiose | Glucose |
| CP811C-300 | BEA | 300 | 0.001 | 0.029 |
| CP-814C | BEA | 38 | 0.003 | 0.057 |
| CP-814E | BEA | 25 | 0.006 | 0.055 |
| RT-12/015A | MFI | 26 | −0.001 | −0.002 |
| RT-12/015C | FAU | 5 | 0.003 | 0.011 |
| RT13-016C | MFI | 41 | −0.002 | −0.001 |
| RT13/016A | BEA | 38 | 0.009 | 0.056 |
| RT13/016B | FAU | 80 | 0.012 | −0.003 |
| CBV-28014 | MFI | 280 | −0.001 | 0.001 |
| CBV-400 | FAU | 5.1 | 0.002 | 0.017 |
| PP1519 | MOR | | 0.008 | 0.026 |
| MP2101 | MOR | | 0.003 | 0.014 |
| AM1787 | BEA | 38 | 0.006 | 0.058 |
| AM1291 | FER | | 0.000 | 0.000 |
| CBV90A | MOR | 90 | −0.001 | 0.015 |

The results show that zeolite BEA yields the highest Glucose loading. From the other zeolytes that were studied only MOR and FAU showed some Glucose adsorption, but the loadings are low and zeolite MFI and FER do not significantly adsorb.

Without wishing to be bound by theory, it is assumed that MFI and FER do not adsorb because of their pore size: the 10-membered-window zeolites have apparently too narrow pores for Glucose to access. The 12-membered-window zeolites BEA, FAU and MOR are accessible. Interestingly, Cellobiose adsorption is low, but most significant in FAU, which has the largest cavity. Moreover, this is zeolite shows Cellobiose and Glucose adsorption selectivity. This could be an indication that pore size selectivity plays a role: FAU has a large cavity in which Cellobiose nicely fits, but is too big for Glucose and MOR and BEA which have smaller cavities with a size large enough able to adsorb glucose, but too small to adsorb Cellobiose. The lower Glucose loading of MOR as compared to BEA may be explained from its lower porosity and lower BET area.

The BEA and MOR adsorption data suggest that a too high SAR (high hydrophobicity) is not preferred since it leads to a lower Glucose loading. The MOR data also indicate a maximum Glucose loading at intermediate SAR. An explanation can be that at low SAR (high hydrophilicity) water adsorption is dominant and inhibiting Glucose adsorption.

### EXAMPLE 2

### Xylose Adsorbtion on Various Zeolites

In this experiment an aqueous solution of xylose was prepared as a model for a hemicellulose hydrolysate. The aqueous solution contains 6 wt % Xylose, 1.5 wt % Acetic Acid, 50 wt % ZnCl₂ and 42.5 wt % water. The adsorption equilibrium experiments are executed according to the procedure as described in Example 1. The results of the sorbent screening test are listed in Table 4.

TABLE 4
Sorbent screening results for a model Hemicellulose hydrolysate.

| | | | Loading, g/g | |
|---|---|---|---|---|
| | | | sorbent | |
| | | | | Acetic |
| Sorbent | Zeotype | SAR | Xylose | acid |
| CP811C-300 | BEA | 300 | 0.015 | 0.052 |
| CP-814C | BEA | 38 | 0.035 | 0.043 |
| CP-814E | BEA | 25 | 0.038 | 0.039 |
| RT-12/015A | MFI | 26 | 0.004 | 0.057 |
| RT-12/015C | FAU | 5 | 0.011 | 0.028 |
| RT13/016A | BEA | 38 | 0.034 | 0.050 |
| RT13/016B | FAU | 80 | 0.001 | 0.028 |
| RT13-016C | MFI | 41 | 0.006 | 0.064 |
| CBV-28014 | MFI | 280 | 0.000 | 0.115 |
| CBV-400 | FAU | 5.1 | 0.016 | 0.044 |
| PP1519 | MOR | | 0.020 | 0.024 |
| MP2101 | MOR | | 0.004 | 0.004 |
| AM1787 | BEA | 38 | 0.038 | 0.041 |
| AM1291 | FER | | −0.001 | 0.034 |
| CBV90A | MOR | 90 | 0.011 | 0.053 |

This table shows that only BEA yields Xylose loading of more than 0.03 g/g sorbent. Acetic Acid has a lower concentration in the solution compared to Xylose, but it is clearly more strongly adsorbed. Acetic Acid can be adsorbed well with all zeotypes. A higher SAR (more hydrophobic sorbent) appears to promote adsorption of acetic acid, but this is not critical.

The adsorption results show that zeolites can adsorb Xylose similarly as found for Glucose in Example 1. Also here the 10-membered pore zeolites (MFI and FER) do not show significant Xylose adsorption. MOR, FAU and BEA do show adsorption and BEA shows a superior loading compared to MOR and FAU. The adsorption of Xylose on FAU appears higher compared to Glucose. The MOR, FAU and BEA data suggest that an intermediate SAR (about 10-50) yields the highest Xylose loading.

### EXAMPLE 3

An adsorption isotherm of Glucose on RT13/016A (BEA) was measured in an aqueous and in a 50% ZnCl₂ solution at room temperature (FIG. 1). For details on these adsorption equilibrium measurements and calculation methods see Example 1.

This example demonstrates that Glucose adsorption on RT13/016A (BEA) follows a Langmuir type isotherm and that the adsorption is strongly enhanced by the presence of 50% ZnCl₂.

### EXAMPLE 4

Aqueous solutions with varying amount of ZnCl₂ were prepared as model compound for a hydrolysate of a cellulose containing biomass which is dissolved and hydrolised in molten salt hydrate ZnCl₂.

Adsorption data of Glucose on zeolite BEA (‘Microspheres’) from solutions containing 8% w Glucose, 0 to 70 wt % ZnCl₂ and 1 wt % HCl is shown in Table 5. The same method as described in Example 1 is used.

TABLE 5
Glucose loading on BEA as a function of ZnCl₂
content with and without addition of 1% HCl.

| | ZnCl₂ mass | | |
|---|---|---|---|
| ZnCl₂ | percentage in | Glucose Loading | |
| mass percentage | solvent*** | with HCl | No HCl |
| 0 | 0 | 0.008 | 0.022 |
| 5 | 5 | 0.009 | 0.020 |
| 10 | 11 | 0.020 | 0.027 |
| 30 | 33 | 0.030 | 0.053 |
| 40 | 43 | | 0.067 |
| 45 | 49 | | 0.073 |
| 50 | 54 | 0.044 | 0.061 |
| 55 | 60 | | 0.059 |
| 60 | 65 | | 0.046 |
| 70 | 76 | 0.015 | −0.003 |

*Solvent is considered as ZnCl₂ and water, excluding sugars and HCl

**Note that in all other cases in the examples the mass fractions or percentages are expressed as part of the solution, i.e. including the sugars, HCl and other components.

Aqueous solutions with varying amount of NaCl were prepared. The same method as described in Example 1 is used to determine adsorption data of Glucose on zeolite BEA (‘Microspheres’) from solutions containing 8% w Glucose, 0-25% w NaCl, and no HCl. The results are shown in Table 6.

TABLE 6
Glucose loading on ‘Microspheres’ (BEA) as a function of NaCl content.

| NaCl | |
|---|---|
| mass | Glucose |
| fraction | loading |
| 0 | 0.021 |
| 5 | 0.026 |
| 10 | 0.048 |
| 15 | 0.045 |
| 20 | 0.055 |
| 24 | 0.066 |

The examples show that with increasing ZnCl₂ content the Glucose loading first increases, has a maximum value around 45 wt % and then decrease strongly to very low loadings. With increasing NaCl a continuously increasing Glucose loading is found. The highest NaCl concentration was close to its solubility (saturation) limit.

The presence of 1% HCl appears to have a significant negative effect on the Glucose loading and in view of the separation it is therefore not preferred to have mineral acid present in the aqueous solution. Although the data also show that it is possible to achieve separation in the presence of an acid, the process of the invention is particularly useful in a process wherein the polysaccharide is hydrolised in the substantial absence of mineral acid.

Without wishing to be bound by theory it is assumed that ZnCl₂ shows a decrease in Glucose loading at concentration higher than 45 wt % due to the fact that with increasing ZnCl₂ content the ion distribution in the solution shifts from C¹⁻ and Zn²⁺ to multi-ion complexes like ZnCl₃⁻ and ZnCl₄²⁻ and less ions and less effective ions are available to promote adsorption.

### EXAMPLE 5

As described in more detail in Example 1, adsorption equilibrium data of Glucose was measured on zeolite ‘Microspheres’ BEA with different types of salts. The initial Glucose content was always 8 wt %. The results are shown in Table 7. A reference measurement without salt is performed (indicated as salt n.a.: non available). The table also shows the Ionic Strength of the solution, which can be calculated from the ion molality (b) and charge number (z) of all species in the solution:

$$I = \frac{1}{2} {\sum }_{i = 1}^{n} {b}_{i} {z}_{i}^{2}$$

TABLE 7
Effect of different salts on the Glucose
loading on ‘Microspheres’ (zeolite BEA)

| | | | Glucose loading, |
|---|---|---|---|
| Salt type | Salt content, % w | Ionic strength, M | g/g zeolite |
| n.a. | n.a. | 0.00 | 0.021 |
| ZnCl₂ | 10.0 | 5.24 | 0.027 |
| ZnCl₂ | 50.0 | 26.20 | 0.063 |
| NaCl | 10.0 | 2.09 | 0.048 |
| NaCl | 20.0 | 4.75 | 0.055 |
| MgCl₂ | 10.0 | 3.84 | 0.034 |
| MgCl₂ | 25.0 | 11.75 | 0.081 |
| CaCl₂ | 15.0 | 5.27 | 0.044 |
| CaCl₂ | 30.0 | 13.08 | 0.072 |
| CuCl₂ | 15.0 | 4.35 | 0.024 |
| CuCl₂ | 30.0 | 10.80 | 0.050 |
| BMIM—Cl* | 30.0 | 2.77 | −0.014 |
| BMIM—Cl | 50.0 | 6.82 | −0.010 |
| HCl | 5.0 | 1.58 | 0.009 |
| HCl | 10.0 | 3.34 | 0.025 |
| H₂SO₄ | 5.0 | 1.76 | 0.004 |
| H₂SO₄ | 20.0 | 8.50 | 0.028 |
| FeCl₂ | 15.0 | 4.61 | 0.043 |
| FeCl₂ | 30.0 | 11.45 | 0.058 |
| Ca(NO₃)₂ | 20.0 | 2.54 | −0.008 |
| Ca(NO₃)₂ | 40.0 | 7.03 | 0.000 |
| MgSO₄ | 7.5 | 2.95 | −0.008 |
| MgSO₄ | 15.0 | 6.47 | −0.005 |
| NaI | 25.0 | 2.49 | 0.001 |
| NaI | 50.0 | 7.94 | −0.009 |
| NaNO₃ | 17.5 | 2.76 | 0.007 |
| NaNO₃ | 35.0 | 7.22 | −0.001 |
| Na₂CO₃ | 7.5 | 1.26 | −0.003 |
| Na₂CO₃ | 15.0 | 2.76 | 0.022 |
| NH₄Cl | 10.0 | 2.28 | 0.009 |
| NH₄Cl | 20.0 | 5.19 | −0.001 |

*BMIM—Cl = 1-Butyl-3-methylimidazolium Chloride

It is clear that the Glucose adsorption is increased by many different salts and is not specific for ZnCl₂ or NaCl. However, for many salts also a reduced Glucose adsorption is found.

In Table 8 the effect of the different salts on the glucose loading are compared at similar Ionic strength (for a type of ion with different counter ions)

TABLE 8
Order in adsorption effect for different ions.

| Ion | Order in loading increasing effect of the counter ion |
|---|---|
| Na⁺ | Cl⁻ > CO₃²⁻ > NO₃⁻ > I⁻ |
| Mg²⁺ | Cl⁻ > SO₄²⁻ |
| Cl⁻ | Na⁺ > Mg²⁺, Ca²⁺, Fe²⁺ > Cu²⁺, H⁺, Zn²⁺ >> NH⁴⁺, BMIM |
| SO₄²⁻ | H⁺ > Mg²⁺ |

It appears that Na+ is better than Zn²⁺, Ca²⁺ and Mg²⁺ and halogenides, in particular Cl are best in increasing glucose loading. It is envisaged that adding monovalent cation salts can further improve the loading increasing effect beyond the maximum effect of bivalent cations like Zn²⁺.

### EXAMPLE 6

As described in more detail in Example 1, adsorption equilibrium data were measured on ‘Microspheres’ BEA with different sugars and acetic acid in an aqueous and 50% w ZnCl₂ solution. The initial content of the organic component was always 8% w. The results are shown in Table 9.

TABLE 9
Loading of Sugars and Acetic Acid on BEA in
water and 50% ZnCl₂ solution.

| | Component loading, g/g sorbent | |
|---|---|---|
| | Water | 50% ZnCl₂ |
| Arabinose | 0.049 | 0.069 |
| Xylose | 0.034 | 0.072 |
| Fructose | 0.029 | 0.073 |
| Glucose | 0.022 | 0.061 |
| Cellobiose | 0.017 | 0.017 |
| Sucrose | −0.008 | 0.002 |
| Acetic Acid | 0.051 | 0.096 |

The monosugars (Glucose, Xylose, Arabinose, Fructose) have a relative low loading in the presence of water, but the loading strongly increases when 50% ZnCl₂ is present in the solution. Clearly a positive effect of ZnCl₂ on 5 and 6 carbon-membered sugars is found. The studied sugar dimers (Sucrose, Cellobiose) have a low loading both in water and in a 50% ZnCl₂ solution. The Acetic Acid loading is also strongly increased by the presence of ZnCl₂.

### EXAMPLE 7

3 Columns with 1 cm diameter were loaded with Microspheres (BEA) to end up with a total column length of 2.55 m. For 5 minutes a synthetic feed representing a cellulose hydrolysate (50% ZnCl₂, 2% Cellobiose, 6% w Glucose) was injected and eluted with water. The flow was in all steps 5 ml min−1 and the temperature was 20° C. The product fractions collected at the column exit were analyzed in the HPLC to calculate the concentrations. A plot of the concentrations as a function of the elution volume is shown in FIG. 2.

This Example demonstrates that Glucose can be separated from both ZnCl₂ and Cellobiose by column chromatography using zeolite BEA (Microspheres). Moreover, separation of cellobiose from ZnCl₂ can be done, albeit much more difficult than Glucose.

### EXAMPLE 8

A solution containing 30% ZnCl₂, 70% water and 0.4 M HCl was prepared. Dried bagasse was contacted with this solution in a mass ratio of 1:10. This mixture was heated to 90° C. for 90 minutes. After the reaction, this mixture was filtered over a 50 micron filter. Then, the filtrate was contacted with fresh bagasse for for 90 minutes at 90° C. After the reaction, this mixture was filtered over a 50 micron filter. The remaining solid was washed thoroughly with water and dried producing a lignocellulosic residue. HCl was removed from the filtered liquid by addition of ZnO and stirring overnight. The liquid was concentrated by water evaporation in a rotavapor up to a ZnCl₂ content of about 50% w. This hydrolysate product was filtered over a 0.2 micron Teflon membrane filter in a Buchner funnel and 16 bed volumes were passed over a column filled with Amberlite XAD₄ at 1 bed volume per hour to remove a large part of the so-called Acid Soluble Lignin (ASL). This treated hemicellulose hydrolysate had the following composition: 45% ZnCl₂, 0.66% Acetic Acid, 4.33% w Xylose, 0.341% Oligomers, 0.42% Glucose, 0.437% Arabinose, 0.054% Acid Soluble Lignin (ASL) and traces of furfural. Note that ASL is measured by UV-vis at 240 nm. This hydrolysate was used in a column experiment as described Example 7. FIG. 3 shows that Xylose can be separated together with Glucose, Arabinose and Acetic from ZnCl₂ and oligomers by column chromatography using zeolite BEA (Microspheres). Part of the oligomer fraction was more strongly adsorbed and was after some time desorbed with a 50% MeOH/water mixture. A large part of the ASL fraction remains with the ZnCl₂/oligomer fraction and part of the ASL is relatively strongly adsorbed and requires a 50% MeOH/water mixture to be desorbed.

### EXAMPLE 9

A break through column experiment was carried out as described Example 7 with the following differences: 1) the injection time was 45 minutes 2) the sorbent was RT13/016A. A plot of the concentrations as a function of the elution volume is shown in FIG. 4.

This example confirms the separation of Glucose from both ZnCl₂ and Cellobiose and more particularly shows that when the Glucose is separated from the ZnCl₂, its separation becomes more difficult because the Glucose loading in the absence of ZnCl₂ is much lower. Now water acts actually as a desorbent for Glucose, leading to a strongly concentrated Glucose peak. For this reason full peak separation of Glucose and ZnCl₂ is difficult and the choice of technology to perform this chromatographic step is very important. Simulated Moving Bed (SMB) technology, for example, would be very suitable to perform this separation since people skilled in the art know that full peak separation on the column is with this technology not required to work at high glucose purity and yield. This is further demonstrated in Example 11. An advantage of the strong desorption of Glucose is that very concentrated product streams can be obtained, whereas typically in chromatography product streams are diluted compared to the original feed.

### EXAMPLE 10

The lignocellulosic residue prepared in example 8 is contacted with a solution of 70% w ZnCl₂ and 0.4 M HCl for 90 minutes at 80° C. After the reaction, this mixture is diluted with water to 50% w ZnCl₂ and filtered over a 50 micron filter.

This filtered hydrolysate product was further filtered over a 0.2 micron Teflon membrane filter in a Buchner funnel and 5 L was fed to a 250 ml column filled with Amberlite XAD7HP at 5 ml min−1 to remove a large part of the so-called Acid Soluble Lignin (ASL). The HCl was neutralized by addition of ZnO and stirring the solution overnight at room temperature.

From HPLC analysis (Biorad Aminex HPX 87H) the following composition was determined of the feed: 47.3% ZnCl₂, 1.7% Oligomers (including Cellobiose), 3.4% Glucose, 0.34% Xylose, 0.017% Arabinose, 0.046% Anhydroglucose and 0.008% Acetic Acid. HMF and furfural were present only in very low concentrations (<0.1%). The solution also contains Acid Soluble Lignin (0.023%) and is light brownish of colour.

A column experiment was carried out as described Example 7, with the following differences: 1) The injected feed was prepared starting from sugar cane bagasse as described above, 2) 30 minutes after the feed injection a 50%/50% MeOH/water was fed to the column. A plot of the concentrations as a function of the elution volume is shown in FIG. 5.

The separation of mono-sugars and acetic acid from ZnCl₂ and cellobiose is confirmed for a real hydrolysate sample. Anhydro-glusose is much stronger adsorbed than the other sugars and can be effectively separated by using an organic desorbent (e.g. 50% MeOH in water in this case) to desorb the anhydro-glucose. The ASL is partly eluted with water, but the largest part is retained on the column and is removed by eluting with 50% MeOH. Organic residues accumulating on the column, like part of the ASL, could be removed by elution with organic solvent like acetone. In case of an SMB configuration an extra regeneration zone can be added. Also using an eluent containing a certain level of organic solvent could be used to prevent accumulation of strongly adsorbing components. People skilled in the art will realize that regeneration will be more efficient at higher temperatures.

### EXAMPLE 11

The separation of a mixture of 50% ZnCl₂, 6% Glucose and 2% w Cellobiose was studied in SMB configuration. The SMB setup was custom made by Knauer/Separations. A schematic drawing is given in FIG. 6.

The SMB configuration consists of 8 columns (0.01×0.85 cm each) divided in 4 zones in a 2-2-2-2 configuration. 4 pumps control the flows in each zone. To simulate the bed movement, the liquid inlet and outlet points are switched in time by 16 7-(6/1)-port valves. The columns were loaded with ‘Microspheres’ and the system was operated at 20° C. In the current experiment the system is operated in open-loop configuration (FIG. 6). The Feed, Extract, Raffinate, Eluent and Waste flows were set to 0.84, 1.92, 2.0, 7.0 and 3.92 ml min−1, respectively. The valve switching time was set to 11.22 min−1. The waste stream contained only traces of the products (<0.01% w).

The yield (Y) and purity (P) in the different product flows (f, f=extract or raffinate) were calculated based on the extract and raffinate volumetric flows (F), density (ρ) and compositions (in weight fractions: xw) according to:

$${P}_{i} = \frac{{x}_{w , i}}{{x}_{w , Glucose} + {x}_{w , Cellobiose} + {x}_{w , ZnCl 2}} 100 \%$$

$${Y}_{i , f} = \frac{{( F ρ {x}_{w , i} )}_{f}}{{( F ρ {x}_{w , i} )}_{Extract} + {( F ρ {x}_{w , i} )}_{Raffinate}} 100 \%$$

Note that in the purity calculation water is excluded.

The results are summarized in Table 10. The results show that Glucose and ZnCl₂ can be separated at high yield and high purity using the SMB technique. The Glucose purity is compromised mainly by the presence Cellobiose, which adsorbs more than ZnCl₂.

Note that the current data are an example and should not be considered representative for an optimized system. Further experiments showed for instance that the productivity could easily increased by a factor 5 without compromising yield and purity, for example in SMB by lowering the switching time and at the same time increasing the flow rates and preferably also increasing the feed flow. Moreover, it was found that the eluent flow used to desorb the Glucose could be reduced at least by a factor 5. This resulted in an extract with more than 15% w Glucose combined with a similar sugar purity as in the current example and further optimization is possible.

TABLE 10
Experimental settings and results of a typical SMB experiment.

| | Feed | Eluent | Extract | Raffinate |
|---|---|---|---|---|
| Flow rate, ml min⁻¹ | 0.84 | 7.0 (3.08**) | 1.92 | 2.0 |
| Density, kg m⁻³ | 1614 | 1000 | 1015 | 1244 |
| Glucose, % w | 6 | 0 | 3.7 | 0.09 |
| Cellobiose, % w | 2 | 0 | 0.16 | 0.99 |
| ZnCl₂, % w | 50 | 0 | 0.14 | 27.6 |
| Glucose yield, % | | | 97.0 | 3.0 |
| Cellobiose yield, % | | | 12.0 | 88.0 |
| ZnCl₂ yield, % | | | 0.5 | 99.5 |
| Glucose purity, % | | | 92.4 | |
| Total sugar purity, %* | | | 96.4 | |

*Total sugar purity considers the sum of Glucose and Cellobiose as desired product.
**Since the system is operated in open loop with a waste flow of 3.92 ml min⁻¹, the effective eluent flow in a closed loop would be 3.08 ml min⁻¹.

### EXAMPLE 12

The experiment described in Example 11 was repeated at 50° C. The data are presented in FIG. 7, together with the results from Example 7, which were measured at 20° C. This example shows that increasing the temperature leads to narrower, more intense peaks with less tailing. The peak separation of Glucose/ZnCl₂ decreases with increasing temperature. Glucose can still be effectively separated at higher temperatures, which is an advantage because the aqueous solution obtained by hydrolysis does not need to be cooled to room temperature.

Thus, the invention has been described by reference to certain embodiments discussed above. It will be recognized that these embodiments are susceptible to various modifications and alternative forms well known to those of skill in the art. Further modifications in addition to those described above may be made to the structures and techniques described herein without departing from the spirit and scope of the invention. Accordingly, although specific embodiments have been described, these are examples only and are not limiting upon the scope of the invention.

What is claimed is:

1. A process for the separation of a monosaccharide from an aqueous solution comprising the monosaccharide and one or more salts and/or mineral acids characterized in that
a. the solution is contacted with a zeolite adsorbent for adsorbing the monosaccharide on the zeolite,
b. one or more salts and/or mineral acids present in the solution improve the adsorbtion process,
c. the zeolite with the adsorbed monosaccharide is separated from the solution,
d. the monosaccharide is separated from the zeolite absorbent.

2. The process according to claim 1, wherein the zeolite is characterised by pore opening with at least 12 T atoms, preferably having a cavity size of less than 1 nm and preferably having a high porosity defined as BET surface area more than 400, preferably more than 450, 500 or even 550 m²/g and preferably has a silica to alumina ratio between 5 and infinite, more preferably between 10 and 150, most preferably between 10 and 50.

3. The process according to anyone of claims 1-2, wherein the zeolite is selected from the group of BEA, MOR or FAU zeolites, preferably the zeolite is BEA zeolite.

4. The process according to anyone of claims 1-3, wherein the salt comprises a cation selected from the group of Na, Li, Ca, Zn, Cu, Fe, Mg and an anion, preferably chloride and the mineral acid preferably is HCl or H₂SO₄.

5. The process according to anyone of claims 1-4, wherein the amount of salt or mineral acid in the aqueous solution is between 1 and 70 wt %, preferably between 5 and 65 wt %, more preferably between 10, 15, 20, 25, 30 or 35 wt % and 65 wt % relative to the total amount of water, salt and mineral acid and, in particular for monovalent cations, most preferably close to the saturation concentration.

6. The process according to anyone of claims 1-5 wherein aqueous solution comprises a salt chosen from the group of ZnCl₂, CaCl₂, LiCl or mixtures thereof, preferably substantially only ZnCl₂, wherein preferably the amount of ZnCl₂, in the aqueous solvent is between 30 and 70 wt %, preferably 40-60 wt % and most preferably 45-55 wt % relative to the total amount of water and salt.

7. The process according to anyone of claims 1-6, wherein the aqueous solution is a hydrolysate of a polysaccharide containing bio-mass.

8. The process according to anyone of claims 1-7, wherein the aqueous solution comprises less than 30, preferably less than 25, 20, 15, 10 or 5 wt % of mono-saccharide derived side products, in particular polyols or anhydro-saccharides and preferably the amount of monosaccharide in the aqueous solution relative to the total amount of polysaccharide hydrolysate (i.e. only saccharide components; not including water and salt) is at least 50 wt %.

9. The process according to anyone of claims 7-8, wherein the aqueous solution is obtained by a process for the conversion of a polysaccharide containing bio-mass, preferably ligno-cellulosic bio-mass, wherein the polysaccharide containing biomass is contacted with an inorganic molten salt hydrate and preferably also a mineral acid and the polysaccharide is dissolved and hydrolysed in the inorganic molten salt hydrate.

10. The process according to claims 7-9 wherein the inorganic molten salt hydrate is chosen from the group of ZnCl₂, CaCl₂, LiCl hydrates or mixtures thereof, preferably at least 60% of the salt in the inorganic molten salt hydrate is ZnCl₂ and most preferably the inorganic molten salt hydrate substantially consists of ZnCl₂ hydrate.

11. The process according to claims 7-10 wherein hemicellulose is selectively hydrolysed in molten ZnCl₂ hydrate wherein the ZnCl₂ salt is present in an amount between 30 and 50 wt %, preferably in presence of a mineral acid, preferably HCl, followed by separation of monosaccharides xylose, glucose and arabinose or wherein cellulose is hydrolysed in molten ZnCl₂ hydrate wherein the ZnCl₂ salt is present in an amount between 62 and 78, more preferably between 65 and 75 and most preferably between 67.5 and 72.5 wt %, preferably in presence of a mineral acid, preferably HCl, followed by separation of monosaccharide glucose or wherein cellulose and hemicellulose are both simultaneously hydrolysed in molten ZnCl₂ hydrate wherein the ZnCl₂ salt is present in an amount between 62 and 78, more preferably between 65 and 75 and most preferably between 67.5 and 72.5 wt % relative to the total amount of water and salt, preferably in presence of a mineral acid, preferably HCl, followed by separation of obtained monosaccharides.

12. The process according to claims 7-11 wherein after the hydrolisation step and before contacting with the zeolite adsorbent, the obtained hydrolysate is diluted to reduce the ZnCl₂ content such that the aqueous solution comprises between 30 and 70 wt %, preferably 40-60 wt % and most preferably 45-55 wt % ZnCl₂ relative to the total amount of water and salt.

13. The process according to anyone of claims 7-12 wherein oligomeric polysaccharides are separated by precipitation with an anti-solvent before or after the separation of the monosaccharides.

14. The process according to anyone of claims 1-13 wherein separation is done in a chromatographic process wherein the zeolite adsorbent is the stationary phase and the eluent is water, preferably at temperatures between 20 and 120° C., wherein the chromatographic process preferably is batch, recycling batch, multi-column or simulated-moving-bed-type process.

15. The process according to claim 14 resulting in an extract comprising between 3 and 40 wt % of the monosaccharide in water and preferably with a yield of preferably more than 90, preferably 95 wt % and a monosaccharide purity of at least 90, preferably 95 wt %.
